(19) United States
(12) Patent Application Publication
(10) Pub. No.: US 2013/0106711 A1
(43) Pub. Date: May 2, 2013

(54) HIERARCHICAL SENSING METHOD

(71) Applicants: Chen-Yu Hou, Hsinchu City (TW); Chin-Hua Kuo, Hsinchu City (TW)

(72) Inventors: Chen-Yu Hou, Hsinchu City (TW); Chin-Hua Kuo, Hsinchu City (TW)

(73) Assignee: Silicon Integrated Systems Corp., Hsinchu City (TW)

(21) Appl. No.: 13/286,195

(22) Filed: Oct. 31, 2011

(51) Int. Cl. G06F 3/041

(52) U.S. Cl. 345/173

(57) ABSTRACT

A hierarchical sensing method for a touch panel is disclosed. The touch panel has a matrix of points for detecting a touch or touches. The method includes dividing the points into a plurality of blocks; selecting several points in each one of the blocks as designated points; sensing first data from each one of the designated points; determining a set of possible touched points according to the first data sensed from each one of the designated points; sensing second data from the set of possible touched points; and determining if each one of the possible touched points is an actual touched point according to the second data sensed from said one possible touched point. By using the present invention method, a faster sensing speed and a greater sensing accuracy can be achieved.

### TECHNICAL FIELD OF THE INVENTION

The present invention relates to a touch sensing technique, more particularly, to a method for sensing a touch or touches on a touch sensitive device.

### BACKGROUND OF THE INVENTION

Nowadays, touch sensitive devices are widely used in various applications. Among those, a touch screen which comprises a touch panel is very popular.

Sensing speed is very important in the performance of a touch panel. FIG. 1 is a schematic diagram showing a touch panel 10 scanned by a conventional method. The touch panel 10 comprises a matrix of points 101. Each point 101 is used to sense a touch. The structure of the touch panel 10 is widely known in this field. In addition, the structure of the touch panel 10 is not the focus or the main issue of the present invention, and therefore detailed descriptions thereof are omitted herein.

As shown in FIG. 1, a dashed circle 50 indicates a touch region. Shadowed points 105 are the points in respect to the touch region 50. That is, the points 105 are the touched points. In the conventional sensing method, the respective points 101 of the touch panel 10 are all scanned and sensed to check for each point being touched or not touched, so as to identify the touched points 105. However, much time is wasted to scan unnecessary points, and as a result, the speed responding a touch or touches to the touch panel 10 is not fast enough.

Therefore, there is a need for a solution to more rapidly identify positions of touch occurring on a touch panel or the like.

### SUMMARY OF THE INVENTION

An objective of the present invention is to provide a hierarchical sensing method, which is capable of improving sensing speed as well as greater accuracy.

In accordance with an aspect of the present invention, a hierarchical sensing method for a touch panel having a matrix of points for detecting a touch or touches comprises: dividing the points into a plurality of blocks; selecting several points in each one of the blocks as designated points; sensing first data from each one of the designated points; determining a set of possible touched points according to the first data sensed from each one of the designated points; sensing second data from the set of possible touched points; and determining if each one of the possible touched points is an actual touched point according to the second data sensed from said one possible touched point. By using the method of the present invention, faster sensing speed and greater sensing accuracy can be achieved.

### BRIEF DESCRIPTION OF THE DRAWINGS

The present invention will be described in detail in conjunction with the appending drawings, in which:

FIG. 1 is a schematic diagram showing a touch panel scanned by a prior art method;

FIG. 2 is a schematic diagram showing a touch panel comprising a matrix of points for detecting a touch or touches in accordance with a first embodiment of the present invention;

FIG. 3 is a schematic diagram showing a single one touch region on the touch panel;

FIG. 4 is a schematic diagram showing three touch regions on the touch panel;

FIG. 5 is a schematic diagram showing designated points 1 relative to the touch regions and the peripheral points around the designated points being determined as the possible touched points and respectively marked an initial counter value;

FIG. 6 is a schematic diagram showing updated counter values of the actual touched points and the un-touched points;

FIG. 7 is a schematic diagram showing the counter values of the actual touched points and the peripheral points around the actual touched points are updated as “6”;

FIG. 8 is a schematic diagram showing first data are sensed from each of the designated points 2 in the first stage of the hierarchical sensing method according to the present invention;

FIG. 9 is a schematic diagram showing updated counter values of the actual touched points and the un-touched points;

FIG. 10 is a schematic diagram showing the counter values of the actual touched points and the peripheral points around the actual touched points are updated as “6”;

FIG. 11 is a schematic diagram showing first data are sensed from each of the designated points 3 in the first stage of the hierarchical sensing method according to the present invention;

FIG. 12 is a schematic diagram showing updated counter values of the actual touched points and the non-touched points;

FIG. 13 is a schematic diagram showing the counter values of the actual touched points and the peripheral points around the actual touched points are updated as “6”;

FIG. 14 is a flow chart showing the hierarchical sensing method in accordance with the present invention; and

FIG. 15 is a schematic diagram showing the additional designated point on the touch panel.

FIG. 16 is a schematic diagram showing another touch panel comprising a matrix of points for detecting a touch or touches.

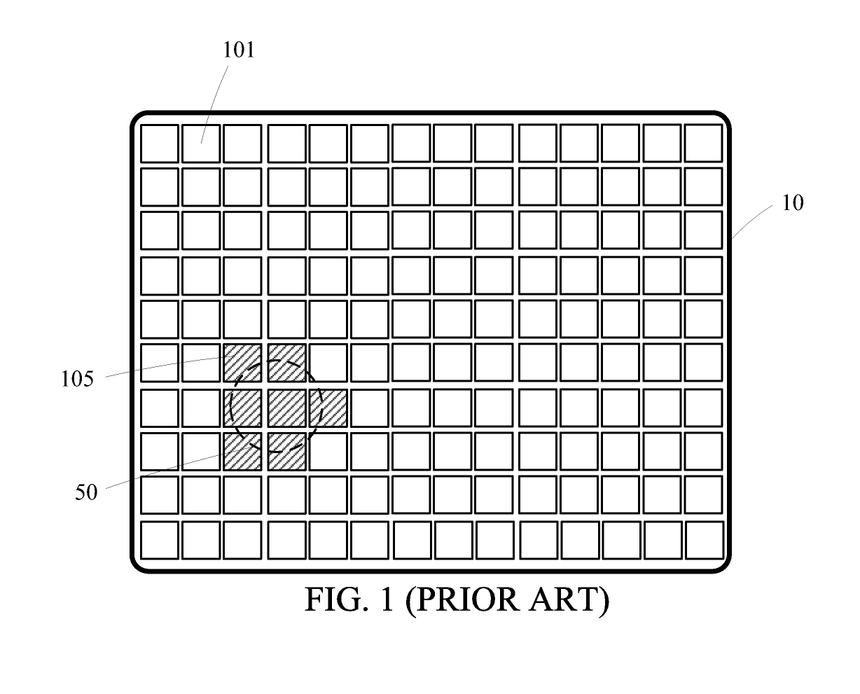

### DETAILED DESCRIPTION OF THE INVENTION

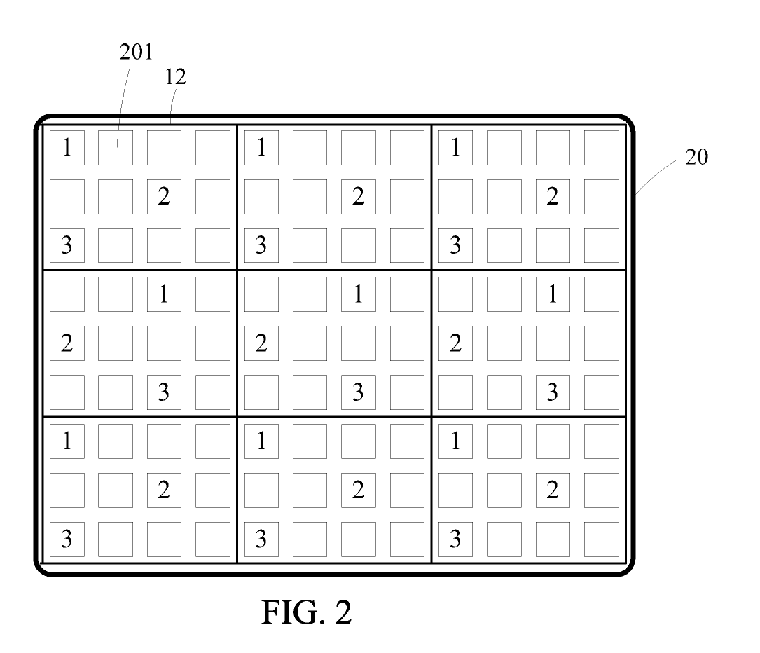

To accelerate sensing speed, the inventor of the present invention proposes a hierarchical sensing method for a touch panel. In the present invention, the hierarchical sensing method comprises two stages, which will be described in detail later. FIG. 2 is a schematic diagram showing a touch panel 20 comprising a matrix of points 201 for detecting a touch or touches. All points 201 of the touch panel 20 are grouped into multiple blocks 12. Each block 12 comprises a plurality of points 201. In the present embodiment, each block 12 includes a 4×3 grid of points 201 (i.e. twelve points 201). Several points 201 in each block 12 are selected as designated points. As shown, each block 12 includes three designated points, which are respectively indicated by reference numbers 1, 2, 3 for descriptive convenience. It is noted that the same reference numbers of the designated points 1, 2, 3 may be located at the same or different positions in respective blocks 12. In the present embodiment, the positions of the designated points 1 in the first and the third rows of the blocks 12 are different from the positions of the designated points 1 in the second row of the blocks 12. The positions of the designated points 2 in the first and third rows of the blocks 12 are different from the positions of the designated points 2 in the second row of blocks. The positions of the designated points 3 in the first and third rows of the blocks 12 are different from the positions of the designated points 3 in the second row of the blocks 12. In one preferred embodiment as shown in FIG. 2, the designated points 1, 2, 3 are uniformly distributed on the touch panel 20. It is noted that each of the blocks 12 is not limited to include three designated points 1, 2, 3. Any other amount of the points 201 may be selected as the designated points.

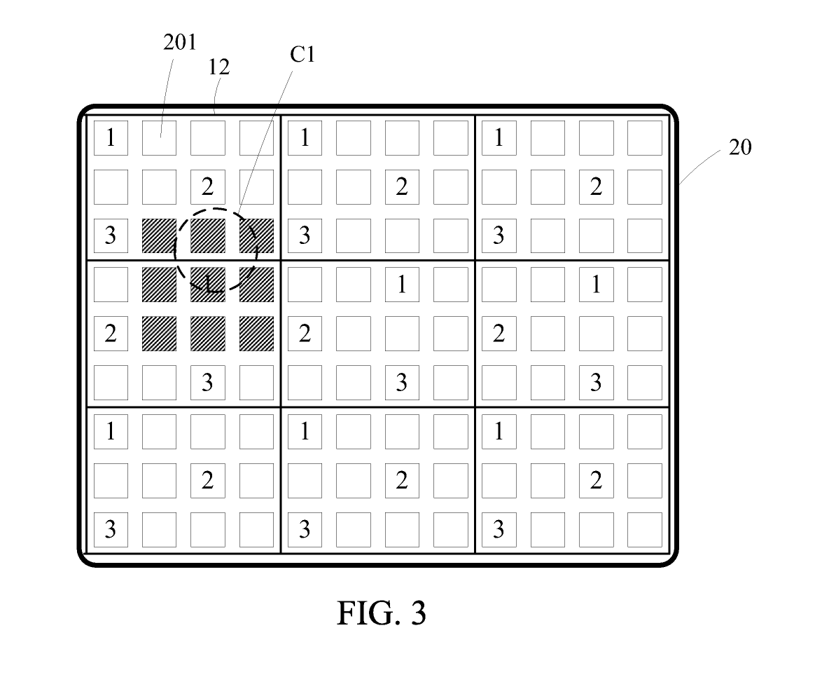

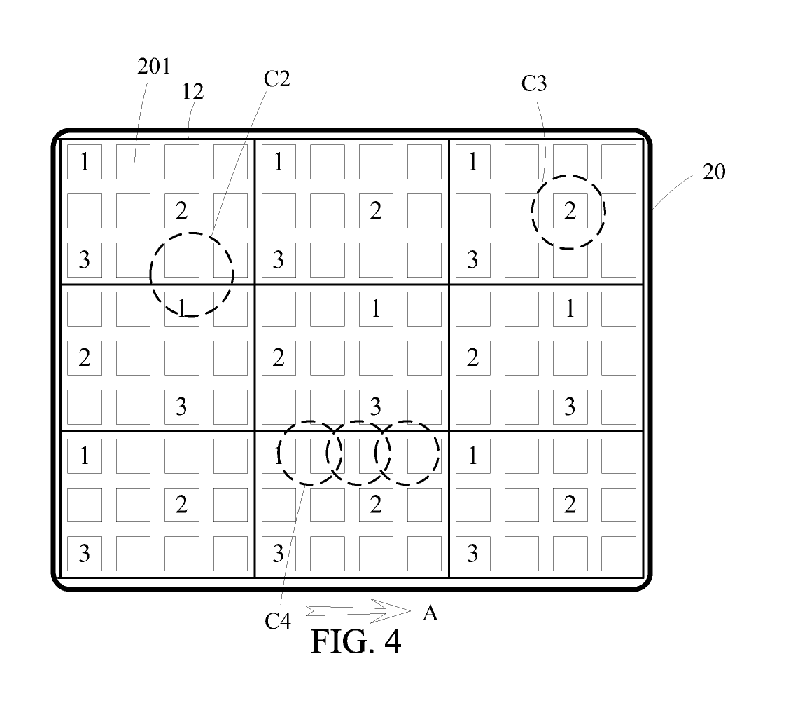

Please refer to FIG. 3, which illustrates a single one touch region C1 touched by an object on the touch panel 20 according to a first embodiment of the present invention. A dashed circle indicates the touch region C1. Initially, first data are sensed from each of the designated points 1 of the blocks 12 in the first stage of the hierarchical sensing method according to the present invention. The sensing time which is required in the first stage of the hierarchical scanning method is only 1/N, where each block comprises N points, as compared to the sensing time required by the conventional point-by-point sensing method. In the present embodiment, each block 12 comprises twelve points 12, and therefore the sensing time required by the first stage of the hierarchical sensing method is 1/12 of the sensing time required by the conventional point-by-point sensing method. It is noted that the first data of each designated point 1 is a sensed value (e.g. capacitance) of said designated point 1. Then, a sensing circuit (not shown) determines a set of possible touched points according to the first data of each designated point 1. More particularly, it is preferred that when the first data of one designated point 1 is greater than a first threshold value, said designated point 1 and peripheral points 201 around said designated point 1 are determined as the possible touched points. The first threshold value functions to avoid erroneous determinations. In the example shown in FIG. 3, one of the designated points 1 is relative to the touch region C1. Therefore, the designated point 1 relative to the touch region C1 and the peripheral points 201 around the one of the designated points 1 are determined as the possible touched points. These possible touched points are represented as shadowed points in FIG. 3. The above-mentioned first stage of the hierarchical sensing method can be referred to as a “designated point scanning stage”.

After the possible touched points (shadowed points) are determined in the first stage of the hierarchical sensing method, second data are sensed from each of the possible touched points (shadowed points) in the second stage of the hierarchical sensing method according to the first embodiment of the present invention. According to the second data of each possible touched point (shadowed points), the possible touched points (shadowed points) are determined as actual touched points. The second data of one possible touched point is a sensed value (e.g. capacitance) of said one possible touched point. More particularly, it is preferred that when the second data of one possible touched point is greater than a second threshold value, said one possible touched point is determined as the actual touched point. The second threshold value functions to avoid erroneous determinations. In the example shown in FIG. 3, six of the nine possible touched points (shadowed points) are relative to the touch region C1, and thus the six of the nine possible touched points (shadowed points) are determined as the actual touched points. The above-mentioned second stage of the hierarchical sensing method can be referred to as a “possible touched point scanning stage”. Therefore, the sensing time for determining the actual touched points can be significantly reduced by firstly sensing the designated points 1 to determine the possible touched points (shadowed points), then determining the actual touched points from sensing the possible touched points.

After the designated points 1 are scanned and sensed, the designated points 2 in respective blocks 12 are scanned and sensed in the first stage of the hierarchical sensing method according to the first embodiment of the present invention. In the present embodiment, not one touch region is found by sensing all of the designated points 2, so that not one point 201 is determined as a possible touched point. Therefore, not one point 201 is determined as an actual touched point in the second stage of the hierarchical sensing method according to the first embodiment of the present invention.

In the same manner, after the designated points 2 are scanned and sensed, the designated points 3 in respective blocks 12 are scanned and sensed in the first stage of the hierarchical sensing method according to the first embodiment of the present invention. In the present embodiment, not one touch region is found by sensing all of the designated points 3, so that not one point 201 is determined as a possible touched point. Therefore, not one point 201 is determined as an actual touched point in the second stage of the hierarchical sensing method according to the first embodiment of the present invention.

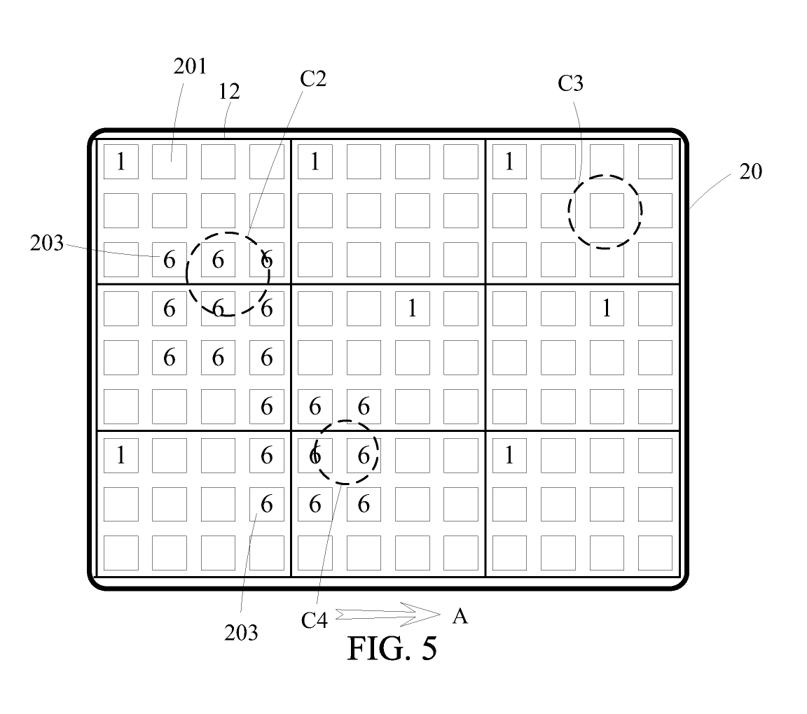

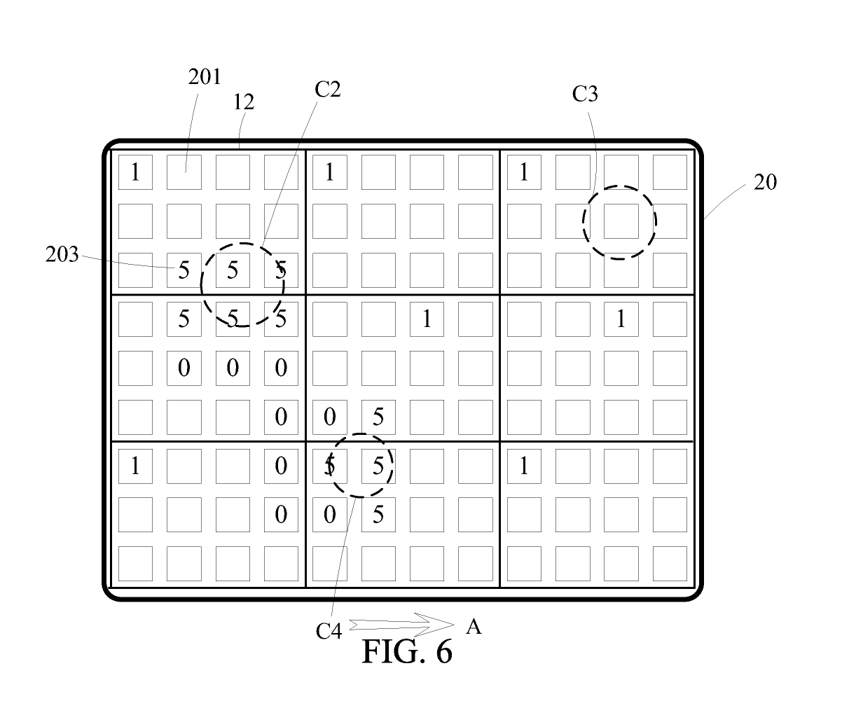

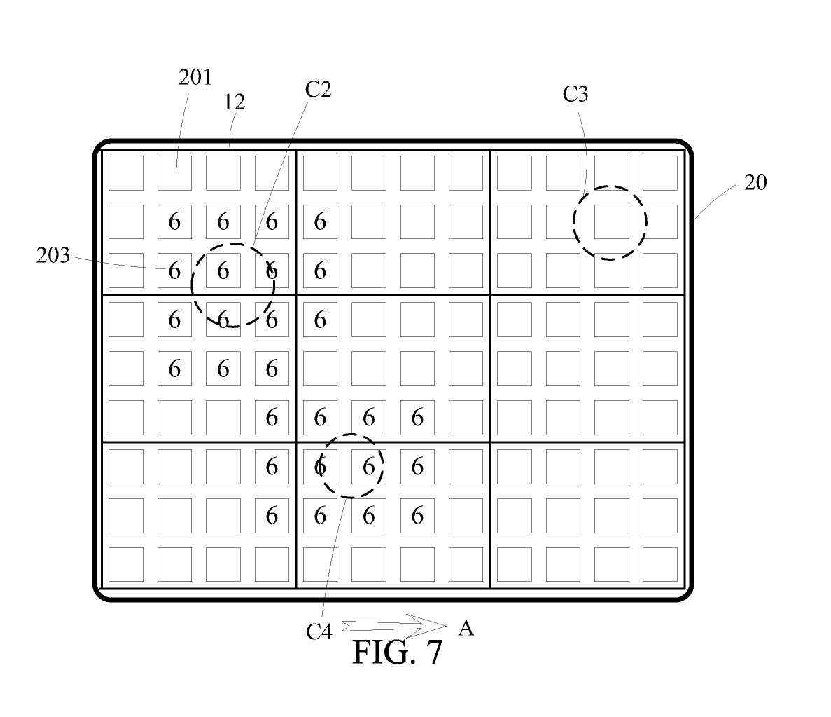

Referring to FIG. 4, which illustrates three touch regions C2, C3, C4 on the touch panel 20 according to a second embodiment of the present invention. Dashed circles respectively indicate the touch regions C2, C3, C4. The touch regions C2, C3 are static (not moving) touch regions, while the touch region C4 is a moving touch region in a direction A. The same reference numbers in FIGS. 2, 4 indicate the same elements. Firstly, first data are sensed from each of the designated points 1 in the first stage of the hierarchical sensing method according to the second embodiment of the present invention. In the present embodiment, the touch regions C2, C4 are found by sensing two of the designated points 1, while the touched region C3 is not found by sensing any one of the designated points 1. The two designated points 1 relative to the touch regions C2, C4 and the peripheral points around the two designated points 1 are determined as the possible touched points and respectively marked an initial counter value, e.g. 6, as shown in FIG. 5. The initial counter values are utilized for avoiding missing the touched points in the following steps of sensing the designated points 2, 3. For sake of a clearer simplistic description, the possible touched points are indicated by another reference numbers 203 as shown in FIG. 5. One or more of the possible touched points 203 are determined as the actual touched point or points according to the second data which are sensed from the possible touched points 203. In the present embodiment, six possible touched points 203 are relative to the touch region C2, and thus the six possible touched points 203 are determined as the actual touched points and the counter values of the six possible touched points 203 are decreased by one. The other three possible touched points 203 are determined as un-touched points and the counter values of said three possible touched points 203 are changed to zero. Four possible touched points 203 are relative to the touch region C4, and thus the four possible touched points 203 are determined as the touched points and the counter values of the four possible touched points 203 are decreased by one. The other five possible touched points 203 are determined as the un-touched points and the counter values of said five possible touched points 203 are changed to zero. FIG. 6 is a schematic diagram showing updated counter values of the actual touched points and the un-touched points. As shown, the counter values of the possible touched points 203 which are determined as un-touched are indicated as “0”, while the counter values of the possible touched points 203 which are determined as touched points becomes “5” (6−1=5). It is noted that any other counter value can be used as required. To avoid missing any point, the counter values of the touched points (i.e. the possible touched points 203 having the counter values of “5”) and the peripheral points around said touched points are updated as “6” as shown in FIG. 7, that is, the actual touched points and the peripheral points around the actual touched points are re-marked as the possible touched points 203.

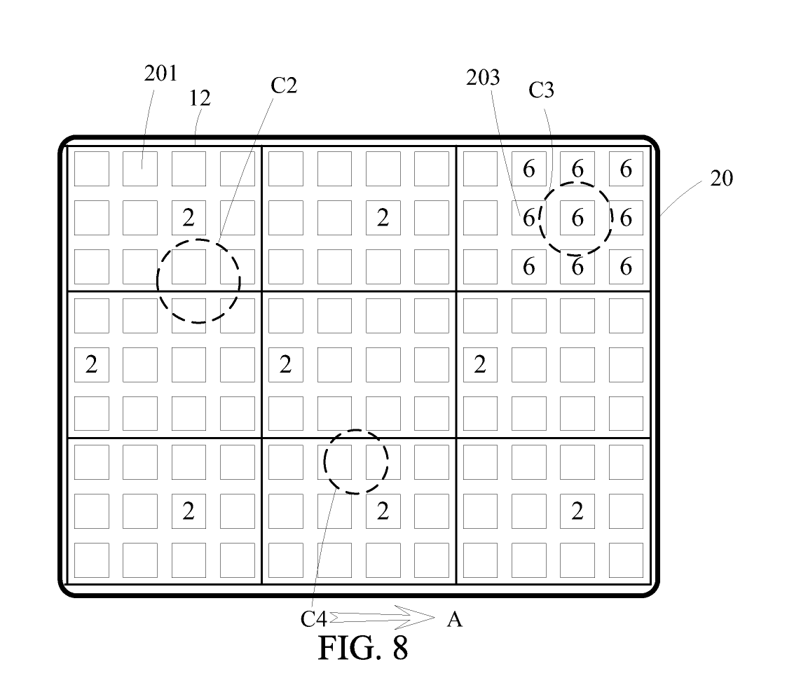

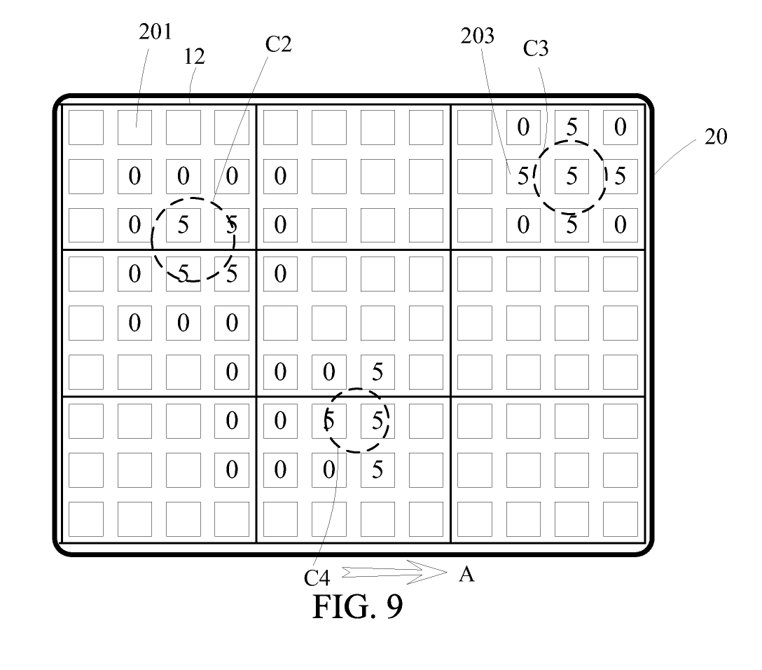

After the designated points 1 are scanned and sensed, the first and second stages of the hierarchical sensing method according to the present invention are performed on the designated points 2. Initially, first data are sensed from each of the designated points 2 in the first stage of the hierarchical sensing method according to the second embodiment of the present invention as shown in FIG. 8. As shown, the touch region C3 can be found by sensing one of the designated points 2, but the touch regions C2, C4 cannot be found by sensing any one of the designated points 2. The one designated point 2 which is relative to the touch region C3 and the peripheral eight points around the one designated point 2 are determined as the possible touched points 203 and respectively marked an initial counter value of “6”. Then, second data are sensed from each of the nine possible touched points 203 in the second stage of the hierarchical sensing method according to the second embodiment of the present invention. In the present embodiment, five possible touched points 203 are relative to the touch region C3, and thus the five possible touched points 203 are determined as touched points and the counter values of the five possible touched points 203 are decreased by one. Furthermore, the second data of the possible touched points 203 in FIG. 7 (i.e. having the counter values of “6”) are also sensed for determining whether the possible touched points 203 in FIG. 7 are touched or not. That is, in the second stage, the second data are sensed from both the possible touched points 203 in FIG. 7 and the possible touched points 203 in FIG. 8 for determining the actual touched points. The counter values of the possible touched points 203 which are determined as un-touched points are “0”, while the counter values of the possible touched points 203 which are determined as touched points become “5” (6−1=5). FIG. 9 is a schematic diagram showing updated counter values of the touched points and the un-touched points. Although the touch regions C2, C4 cannot be found by scanning any one of the designated points 2, the touch regions C2, C4 still can be found by scanning the possible touched points 203 in FIG. 7 since the possible touched points 203 which are relative to the touch regions C2, C4 in FIG. 7 are re-marked with the counter values of “6”.

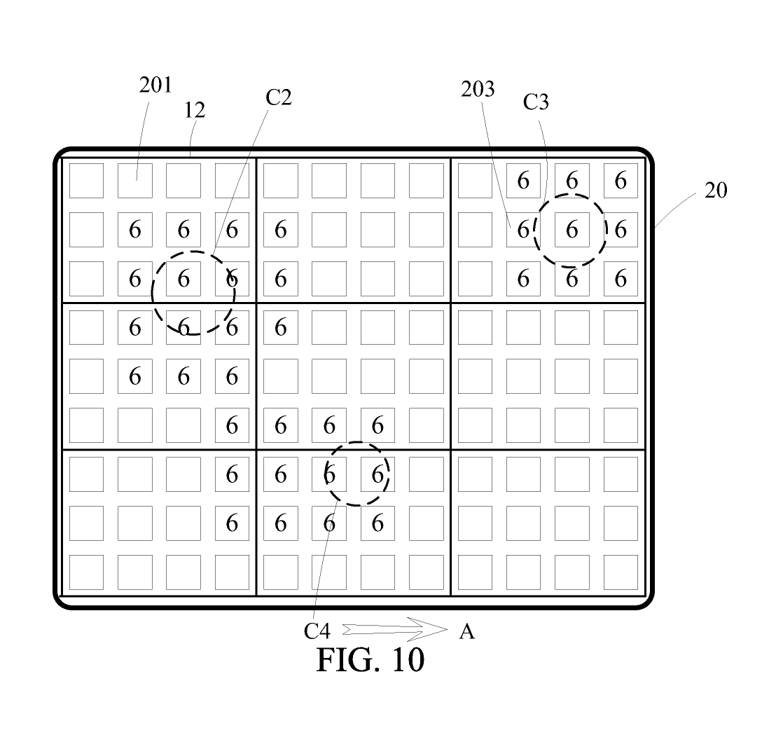

It is noted that the touch region C4 is moving from the position in FIG. 6 to the position in FIG. 9 in the direction A. Since the counter values of the peripheral points around the possible touched points 203 which are relative to the touch region C4 in FIG. 6 are re-marked as “6”, the touch region C4 still can be found even if the touch region C4 is moving. That is, the hierarchical sensing method according to the present invention is capable of detecting a moving touch. To avoid missing any point in the following step of scanning the designated points 3, the counter values of the actual touched points (i.e. having the counter values of “5”) and the peripheral points around the actual touched points are updated as “6” as shown in FIG. 10, that is, are re-marked as the possible touched points 203.

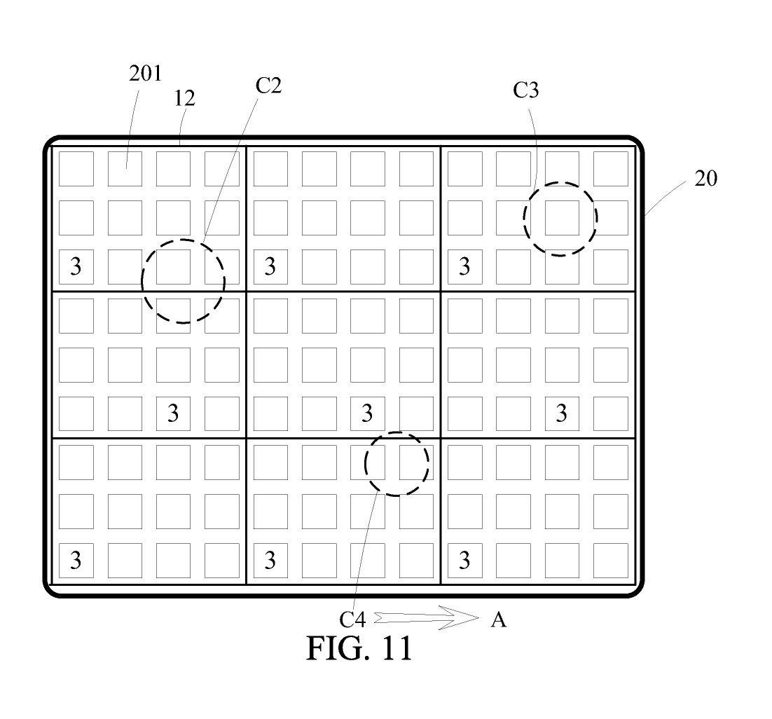

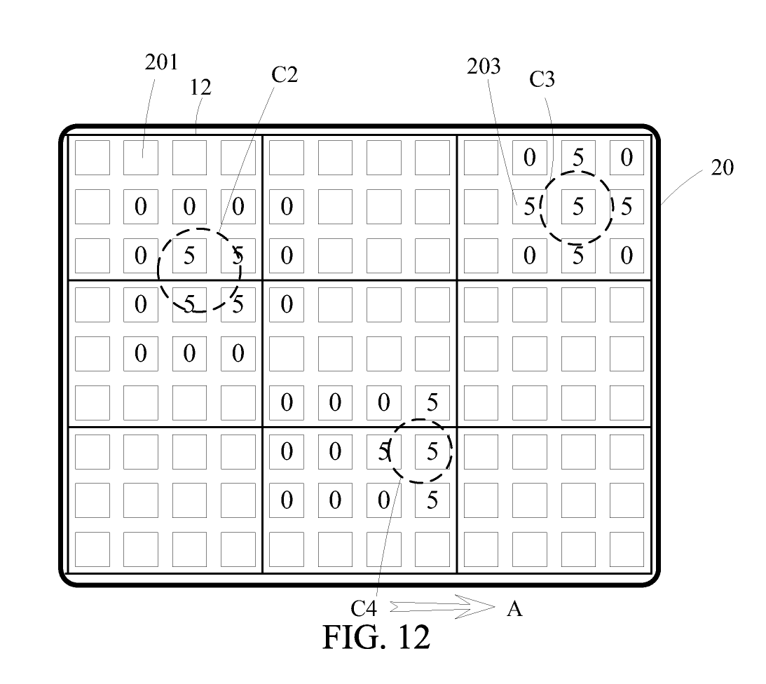

After the designated points 2 are scanned and sensed, the first and second stages of the hierarchical sensing method according to the present invention are performed on the designated points 3. Initially, first data are sensed from each of the designated points 3 in the first stage of the hierarchical sensing method according to the second embodiment of the present invention as shown in FIG. 11. Not one touch region is found when scanning the designated points 3, that is, not one possible touched point is determined in the first stage of the hierarchical sensing method according to the present invention. However, the second data of the possible touched points 203 in FIG. 10 (i.e. having the counter values of “6”) are sensed for determining whether the possible touched points 203 in FIG. 10 are touched or not in the second stage of sensing the designated points 3. According to the second data, the counter values of the possible touched points 203 which are determined as un-touched points are “0”, while the counter values of the possible touched points become “5” (6−1=5). FIG. 12 is a schematic diagram showing updated counter values of the touched points and the un-touched points. Although the touch regions C2, C3, C4 cannot be found by scanning any one of the designated points 3, the touch regions C2, C3, C4 can be found by scanning the possible touched points 203 which are marked with the counter values of “6” in FIG. 10.

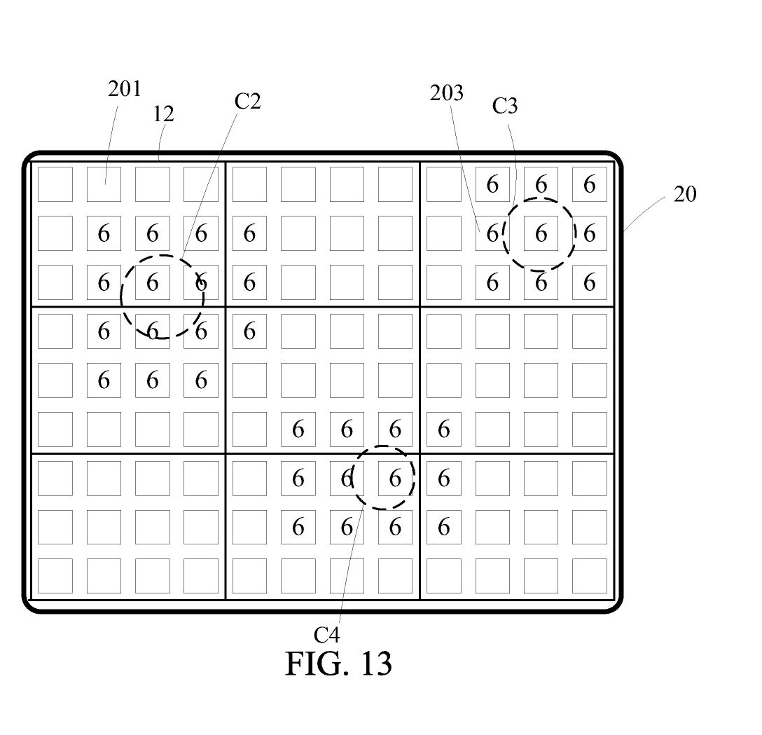

It is noted that the touch region C4 is moving from the position in FIG. 9 to the position in FIG. 12 in the direction A. Since the counter values of the peripheral points around the possible touched points 203 which are relative the touch region C4 in FIG. 9 are re-marked as “6”, the touch region C4 still can be found even if the touch region C4 is moving. To avoid missing any point in the following steps, the counter values of the touched points (i.e. having the counter values of “5”) and the peripheral points around the touched points are updated as “6” as shown in FIG. 13, that is, are re-marked as the possible touched points 203.

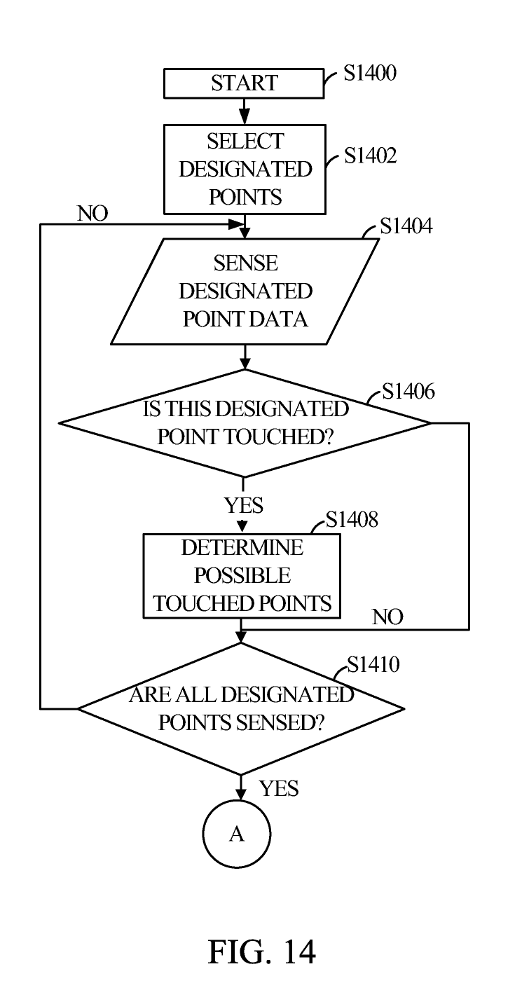

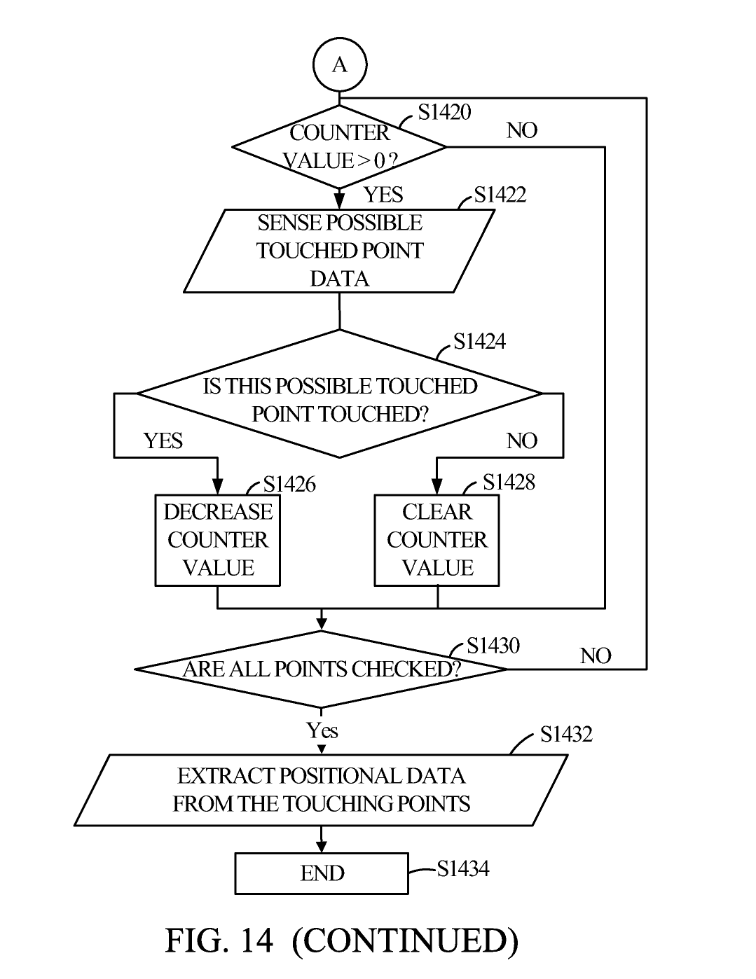

To more clarify the implementations of the present invention, FIG. 14 is a flow chart showing the hierarchical sensing method in accordance with the present invention. In step S1400, the process starts. In step S1402, designated points are selected as described above. In step S1404, first data is sensed from one of the designated point. In step S1406, it is determined said one of the designated points is touched or not touched according to the first data obtained. If said one designated point is determined as a touched point, said one designated point and peripheral points around said designated point are determined as the possible touched points in step S1408. In step S1410, it is checked if all of the designated points have been sensed. The steps S1402 to S1410 are subordinate to the designated point scanning stage.

In step S1420, the counter value of each possible touched point is checked to see if it is non-zero. If the counter value of a possible touched point is non-zero, then the data (i.e. point sensed value) of this possible touched point is sensed in step S1422. In step S1424, the point having a non-zero counter value is checked to determine if it is touched. It is noted that any point which is a possible touched point but has a non-zero counter value will be also sensed. If the point is touched, the counter value thereof is decreased (e.g. minus one) in step S1426. If the point is not touched, then the counter value of this point is cleared (i.e. reset to zero) in step S1428. In step S1430, it is determined if all of the possible touched points have been checked. The steps S1420 to S1430 are subordinate to the possible touched point scanning stage. After all of the possible touched points are checked, positional data are extracted from the possible touched points in step S1432. The process ends in step S1434.

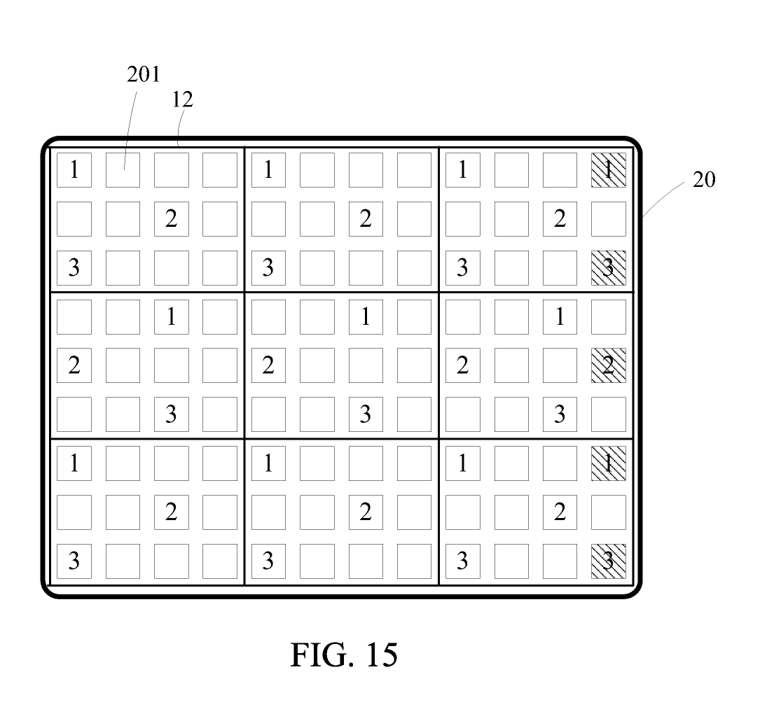

As mentioned above, it is preferred that the designated points are uniformly distributed on the touch panel. If there is not any one designated point on one edge of the touch panel, additional designated point or points can be selected for improving accuracy of the hierarchical sensing method of the present invention. For example, there is not any one of the designated points 1, 2, 3 on the right edge of the touch panel 20 in FIG. 2. To avoid missing points, the additional designated points 1, 2, 3 which are represented as dotted points in FIG. 15 are selected for avoiding missing points.

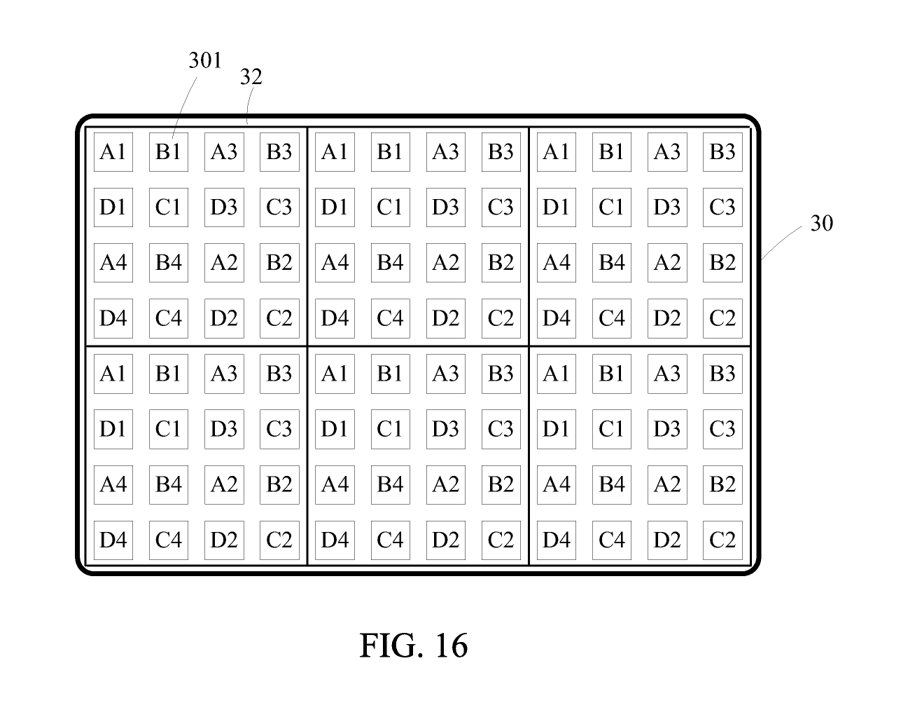

Furthermore, to increase the accuracy of the hierarchical sensing method of the present invention, several sets of designated points can be selected. In FIG. 2, the three designated points 1, 2, 3 are regarded as a set. FIG. 16 is a schematic diagram showing another touch panel 30 comprising a matrix of points 301 for detecting a touch or touches. All points 301 of the touch panel 30 are grouped into multiple blocks 32. Each block 32 comprises a plurality of points 301. In the present embodiment, each block 32 includes a 4×4 grid of points 301 (i.e. sixteen points 301). There are four sets of designated points in FIG. 16. The first set of designated points includes A1, A2, A3, and A4. The second set of designated points includes B1, B2, B3, and B4. The third set of designated points includes C1, C2, C3, and C4. The fourth set of designated points includes D1, D2, D3, and D4. The sensing processes are the same as those in FIGS. 4-13 and omitted herein. Accordingly, the hierarchical sensing method of the present invention can cover the touch panel 30 by sequentially sensing the designated points A1, A2, A3, A4, B1, B2, B3, B4, C1, C2, C3, C4, D1, D2, D3, and D4.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A hierarchical sensing method for a touch panel, said touch panel comprising a matrix of points for detecting a touch or touches, said method comprising:
dividing the points into a plurality of blocks, each block comprising a plurality of points;
selecting several points in each one of the blocks as designated points;
sensing first data from each one of the designated points;
determining a set of possible touched points according to the first data sensed from each one of the designated points;
sensing second data from the set of possible touched points; and
determining if each one of the possible touched points is an actual touched point according to the second data sensed from said one possible touched point.

2. The hierarchical sensing method of claim 1, wherein the first data of one designated point is a sensed value of said designated point.

3. The hierarchical sensing method of claim 2, wherein the first data of one designated point is a capacitance sensed from said designated point.

4. The hierarchical sensing method of claim 1, wherein the second data of one possible touched point is a sensed value of said possible touched point.

5. The hierarchical sensing method of claim 4, wherein the second data of one possible touched point is a capacitance sensed from said possible touched point.

6. The hierarchical sensing method of claim 1, wherein the designated points are uniformly distributed on the touch panel.

7. The hierarchical sensing method of claim 1, wherein when the first data sensed from one of the designated points is greater than a first threshold value, said one designated point is determined as the possible touched point, and peripheral points around said one designated point are determined as the possible touched points.

8. The hierarchical sensing method of claim 1, wherein when the second data sensed from one of the possible touched point is greater than a second threshold value, said one possible touched point is determined as the actual touched point.

9. The hierarchical sensing method of claim 1, wherein the step of determining if each one of the possible touched points is an actual touched point according to the second data sensed from said one possible touched point further comprising:
designating a counter value for each one of the possible touched points; and
clearing the counter value of a possible touched point when it is determined that said possible touched point is not an actual touched point, while decreasing the counter value of a possible touched point when it is determined that said possible touched point is an actual touched point.

10. The hierarchical sensing method of claim 9, wherein after it is determined that said possible touched point is an actual touched point, the counter value is designated for said possible touched point and each peripheral point around said possible touched point.
